(19) United States
(12) Patent Application Publication
(10) Pub. No.: US 2025/0233921 A1
(43) Pub. Date: Jul. 17, 2025

(54) ELECTRONIC DEVICE FOR MANAGING KEEP ALIVE PERIOD AND OPERATING METHOD THEREOF

(71) Applicant: Samsung Electronics Co., Ltd., Suwon-si (KR)

(72) Inventors: Sangmook KIM, Suwon-si (KR); Dongho LIM, Suwon-si (KR); Ahyoung CHO, Suwon-si (KR); Seunghwan HWANG, Suwon-si (KR)

(21) Appl. No.: 19/071,073

(22) Filed: Mar. 5, 2025

Related U.S. Application Data
(63) Continuation of application No. PCT/KR2023/011575, filed on Aug. 7, 2023.

(30) Foreign Application Priority Data
Sep. 22, 2022 (KR) 10-2022-0119986
Oct. 6, 2022 (KR) 10-2022-0128180

(51) Int. Cl. H04L 67/145

(52) U.S. Cl. CPC H04L 67/145

(57) ABSTRACT

An electronic device is provided. The electronic device includes memory storing one or more computer programs, at least one communication circuit, and one or more processors communicatively coupled to the memory and the at least one communication circuit, wherein the one or more computer programs include computer-executable instructions that, when executed by the one or more processors individually or collectively, cause the electronic device to control the at least one communication circuit to establish a connection with a server, identify whether at least one of a first condition or a second condition related to a reception delay in the connection is satisfied, and based on the at least one of the first condition or the second condition being satisfied, adjust a keep alive period for the connection, wherein the first condition includes a condition that a first reception delay time related to a keep alive message exceeds a threshold delay time, and wherein the second condition includes a condition that a second reception delay time related to a session layer message exceeds the threshold delay time.

### CROSS-REFERENCE TO RELATED APPLICATION(S)

This application is a continuation application, claiming priority under 35 U.S.C. § 365(c), of an International application No. PCT/KR2023/011575, filed on Aug. 7, 2023, which is based on and claims the benefit of a Korean patent application number 10-2022-0119986, filed on Sep. 22, 2022, in the Korean Intellectual Property Office, and of a Korean patent application number 10-2022-0128180, filed on Oct. 6, 2022, in the Korean Intellectual Property Office, the disclosure of each of which is incorporated by reference herein in its entirety.

### BACKGROUND

### 1. Field

The disclosure relates to an electronic device for managing a keep alive period and an operating method thereof.

### 2. Description of Related Art

A keep alive mechanism for periodically checking network status has been applied to various services, and a representative example thereof may be a voice over internet protocol (VOIP) service (e.g., a call and message continuity (CMC) service).

The CMC service may include a service which extends a telephone function and/or a text messaging function of an electronic device (e.g., a smart phone) to at least one external electronic device (e.g., a tablet and/or a smart watch) registered based on a user account identical to a user account of the electronic device. Since the CMC service extends the telephone function and/or the text messaging function based on a universal subscriber identity module (USIM) of a communication carrier to which the electronic device is subscribed, there may be no need for the USIM to be inserted into the external electronic device.

The telephone function provided in the CMC service may use a session initiation protocol (SIP) for signaling. The telephone function provided in the CMC service, which is the VoIP service, may have a characteristic which is very sensitive to reception delay (e.g., packet delay). However, since packets in the CMC service are transmitted and received through a general Internet network except for a server (e.g., an application server (AS) or a CMC server), it may be very difficult to manage delay which occurs between endpoint electronic devices.

Since the CMC service does not support dedicated network resources provided through an operator network, a keep alive operation may be essential to maintain a transmission control protocol (TCP) connection between the electronic device and/or external electronic device and the CMC server. If a keep alive period is set to be relatively long in the electronic device and/or external electronic device, packet delay may occur due to at least some of routers existing in an Internet core network.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for managing a keep alive period and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, at least one communication circuit, and one or more processors communicatively coupled to the memory and the at least one communication circuit, wherein the one or more computer programs include computer-executable instructions that, when executed by the one or more processors individually or collectively, cause the electronic device to control the at least one communication circuit to establish a connection with a server, identify whether at least one of a first condition or a second condition related to a reception delay in the connection is satisfied, and based on the at least one of the first condition or the second condition being satisfied, adjust a keep alive period for the connection, wherein the first condition includes a condition that a first reception delay time related to a keep alive message exceeds a threshold delay time, and the second condition includes a condition that a second reception delay time related to a session layer message exceeds the threshold delay time.

In accordance with another aspect of the disclosure, a method performed by an electronic device is provided. The method includes establishing, by the electronic device, a connection with a server, identifying, by the electronic device, whether at least one of a first condition or a second condition related to a reception delay in the connection is satisfied, and based on the at least one of the first condition or the second condition being satisfied, adjusting, by the electronic device, a keep alive period for the connection, wherein the first condition includes a condition that a first reception delay time related to a keep alive message exceeds threshold delay time, and wherein the second condition includes a condition that a second reception delay time related to a session layer message exceeds the threshold delay time.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include establishing, by the electronic device, a connection with a server, identifying, by the electronic device, whether at least one of a first condition or a second condition related to a reception delay is satisfied, and based on the at least one of the first condition or the second condition being satisfied, adjusting, by the electronic device, a keep alive period for the connection, wherein the first condition includes a condition that a first reception delay time related to a keep alive message exceeds a threshold delay time, and wherein the second condition includes a condition that a second reception delay time related to a session layer message exceeds the threshold delay time.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram schematically illustrating an electronic device within a network environment according to an embodiment of the disclosure;

FIG. 2A is a block diagram illustrating an electronic device for supporting a legacy network communication and a 5^{th} generation (5G) network communication according to an embodiment of the disclosure;

FIG. 2B is a block diagram illustrating an electronic device for supporting a legacy network communication and a 5G network communication according to an embodiment of the disclosure;

FIG. 3 is a diagram illustrating a network environment in which a keep alive mechanism is applied according to an embodiment of the disclosure;

FIG. 4 is a flowchart illustrating an operating process of an electronic device according to an embodiment of the disclosure;

FIG. 5 is a diagram for explaining second reception delay time related to a session layer message according to an embodiment of the disclosure;

FIG. 6 is a diagram for explaining an operating of adjusting a keep alive period in a case that first reception delay time related to a keep alive message exceeds threshold delay time according to an embodiment of the disclosure;

FIG. 7 is a diagram for explaining an operating of adjusting a keep alive period in a case that first reception delay time related to a keep alive message exceeds threshold delay time according to an embodiment of the disclosure;

FIG. 8 is a diagram for explaining an operating of sharing a keep alive period between electronic devices according to an embodiment of the disclosure;

FIG. 9 is a diagram for explaining an operating of sharing a keep alive period between electronic devices according to an embodiment of the disclosure; and

FIG. 10 is a diagram for explaining an operating of sharing a keep alive period between electronic devices according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, such an expression as “comprises” or “include”, or the like should not be interpreted to necessarily include all elements or all operations described in the specification, and should be interpreted to be allowed to exclude some of them or further include additional elements or operations.

Alternatively, the terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Hereinafter, an embodiment of the disclosure will be described in detail with reference to the accompanying drawings. Regardless of drawing signs, the same or like elements are provided with the same reference numeral, and a repeated description thereof will be omitted. Alternatively, in describing an embodiment of the disclosure, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, an embodiment of the disclosure will describe an electronic device as an example, but the electronic device may be referred to as a terminal, a mobile station, a mobile equipment (ME), a user equipment (UE), a user terminal (UT), a subscriber station (SS), a wireless device, a handheld device, and an access terminal (AT). Alternatively, in an embodiment of the disclosure, the electronic device may be a device having a communication function such as, for example, a mobile phone, a personal digital assistant (PDA), a smart phone, a wireless MODEM, and a notebook.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

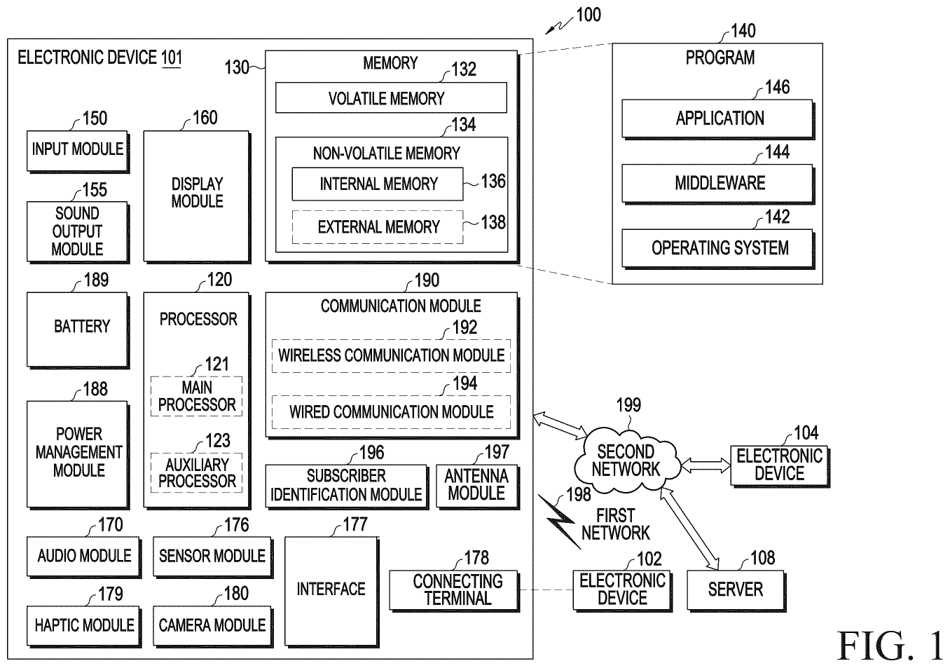

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) (a tablet and/or a smart watch) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 and 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to a particular embodiment and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

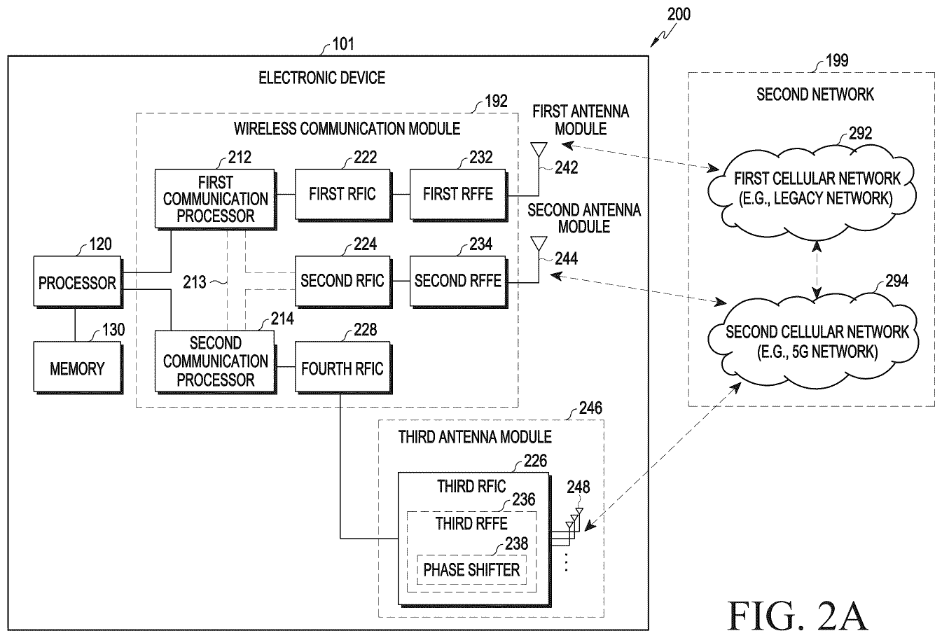

FIG. 2A is a block diagram 200 illustrating an electronic device 101 for supporting a legacy network communication and a 5^{th} generation (5G) network communication according to an embodiment of the disclosure.

Referring to FIG. 2A, an electronic device 101 (e.g., an electronic device 101 in FIG. 1) may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120 and memory 130. A second network 199 may include a first cellular network 292 and a second cellular network 294. According to an embodiment, the electronic device 101 may further include at least one of the components illustrated in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of a wireless communication module 192. According to an embodiment, the fourth RFIC 228 may be omitted or included as part of the third RFIC 226.

The first communication processor 212 may establish a communication channel in a band to be used for a wireless communication with the first cellular network 292 and support a legacy network communication via the established communication channel. According to an embodiment, the first cellular network 292 may be a legacy network including a 2^{nd} generation (2G) network, a 3^{rd} generation (3G) network, a 4^{th} generation (4G) network, or a long term evolution (LTE) network. The second communication processor 214 may establish a communication channel corresponding to a specified band (e.g., about 6 GHz to about 60 GHz) out of a band to be used for a wireless communication with the second cellular network 294 and support a 5G network communication via the established communication channel. According to an embodiment, the second cellular network 294 may be a 5G network defined by the 3rd generation partnership project (3GPP). Additionally, according to an embodiment, the first communication processor 212 or the second communication processor 214 may establish a communication channel corresponding to another specified band (e.g., about 6 GHz or less) out of the band to be used for the wireless communication with the second cellular network 294 and support a 5G network communication via the established communication channel.

The first communication processor 212 may transmit and receive data to and from the second communication processor 214. For example, data supposed to be transmitted via the second cellular network 294 may be scheduled to be transmitted via the first cellular network 292. In this case, the first communication processor 212 may receive transmission data from the second communication processor 214. For example, the first communication processor 212 may transmit and receive data to and from the second communication processor 214 via an inter-processor interface 213. The inter-processor interface 213 may be implemented as, for example, a universal asynchronous receiver/transmitter (UART) (e.g., high speed-UART (HS-UART)) or a peripheral component interconnect bus express (PCIe) interface, but a type thereof is not limited. Alternatively, the first communication processor 212 and the second communication processor 214 may exchange control information and packet data information by using, for example, shared memory. The first communication processor 212 may transmit and receive various pieces of information such as sensing information, information about output strength, and resource block (RB) allocation information to and from the second communication processor 214.

According to an embodiment, the first communication processor 212 may not be coupled directly to the second communication processor 214. In this case, the first communication processor 212 may transmit and receive data to and from the second communication processor 214 via the processor 120 (e.g., an application processor). For example, the first communication processor 212 and the second communication processor 214 may transmit and receive data to and from the processor 120 via an HS-UART interface or a PCIe interface, but a type of an interface is not limited. Alternatively, the first communication processor 212 and the second communication processor 214 may exchange control information and packet data information by using, for example, the processor 120 and the shared memory.

According to an embodiment, the first communication processor 212 and the second communication processor 214 may be incorporated in a single chip or a single package. According to an embodiment, the first communication processor 212 or the second communication processor 214 may be incorporated together with the processor 120, an auxiliary processor 123, or a communication module 190 in a single chip or a single package.

FIG. 2B is a block diagram illustrating an electronic device for supporting a legacy network communication and a 5G network communication according to an embodiment of the disclosure.

Referring to FIG. 2B, an integrated communication processor 260 may support all of a function for a communication with the first cellular network 292 and a function for a communication with the second cellular network 294.

For transmission, the first RFIC 222 may convert a baseband signal generated by the first communication processor 212 to a radio frequency (RF) signal in about 700 MHz to about 3 GHz used in the first cellular network 292 (e.g., the legacy network). For reception, an RF signal may be obtained from the first cellular network 292 via an antenna (e.g., the first antenna module 242) and pre-processed via an RFFE (e.g., the first RFFE 232). The first RFIC 222 may convert the pre-processed RF signal to a baseband signal so that the baseband signal may be processed by the first communication processor 212.

For transmission, the second RFIC 224 may convert a baseband signal generated by the first communication processor 212 or the second communication processor 214 to an RF signal in a Sub6 band (e.g., about 6 GHz or less) used in the second cellular network 294 (e.g., the 5G network). For reception, a 5G Sub6 RF signal may be obtained from the second cellular network 294 via an antenna (e.g., the second antenna module 244) and pre-processed in an RFFE (e.g., the second RFFE 234). The second RFIC 224 may convert the pre-processed 5G Sub6 RF signal to a baseband signal so that the baseband signal may be processed by a corresponding one between the first communication processor 212 and the second communication processor 214.

For transmission, the third RFIC 226 may convert a baseband signal generated by the second communication processor 214 to an RF signal (hereinafter, referred to as, a 5G Above6 RF signal) in a 5G Above6 band (e.g., about 6 GHz to about 60 GHz) used in the second cellular network 294. For reception, a 5G Above6 RF signal may be obtained from the second cellular network 294 via an antenna (e.g., the antenna 248) and pre-processed via the third RFFE 236. The third RFIC 226 may convert the pre-processed 5G Above6 RF signal to a baseband signal so that the baseband signal may be processed by the second communication processor 214. According to an embodiment, the third RFFE 236 may be formed as part of the third RFIC 226.

According to an embodiment, the electronic device 101 may include the fourth RFIC 228 separately from or as part of the third RFIC 226. In this case, the fourth RFIC 228 may convert a baseband signal generated by the second communication processor 214 to an RF signal in an intermediate frequency band (e.g., about 9 GHz to about 11 GHZ) (hereinafter, referred to as an intermediate frequency (IF) signal), and provide the IF signal to the third RFIC 226. The third RFIC 226 may convert the IF signal to a 5G Above6 RF signal. During reception, a 5G Above6 RF signal may be received from the second cellular network 294 through an antenna (e.g., the antenna 248) and converted to an IF signal by the third RFIC 226. The fourth RFIC 228 may convert the IF signal to a baseband signal so that the baseband signal may be processed by the second communication processor 214.

According to an embodiment, the first RFIC 222 and the second RFIC 224 may be implemented as at least part of a single chip or a single package. According to an embodiment, if the first RFIC 222 and the second RFIC 224 are implemented as a single chip or a single package in FIG. 2A or 2B, the first RFIC 222 and the second RFIC 224 may be implemented as an integrated RFIC. In this case, the integrated RFIC is connected to the first RFFE 232 and the second RFFE 234, so the integrated RFIC may convert a baseband signal into a signal of a band supported by the first RFFE 232 and/or the second RFFE 234, and transfer the converted signal to one of the first RFFE 232 and the second RFFE 234. According to an embodiment, the first RFFE 232 and the second RFFE 234 may be implemented as at least part of a single chip or a single package. According to an embodiment, at least one of the first antenna module 242 or the second antenna module 244 may be omitted or combined with the other antenna module to process RF signals in a plurality of corresponding bands.

According to an embodiment, the third RFIC 226 and the antenna 248 may be arranged on the same substrate to form a third antenna module 246. For example, the wireless communication module 192 or the processor 120 may be arranged on a first substrate (e.g., a main PCB). In this case, the third RFIC 226 may be arranged in a partial area (e.g., the bottom surface) of a second substrate (e.g., a sub PCB) other than the first substrate and the antenna 248 may be arranged in another partial area (e.g., the top surface) of the second substrate, to form the third antenna module 246. As the third RFIC 226 and the antenna 248 are arranged on the same substrate, it is possible to reduce length of a transmission line between the third RFIC 226 and the antenna 248. This may reduce, for example, loss (e.g., attenuation) of a signal in a high frequency band (e.g., about 6 GHz to about 60 GHz) used for a 5G network communication, on the transmission line. Therefore, the electronic device 101 may increase quality or a speed of a communication with the second cellular network 294 (e.g., the 5G network).

According to an embodiment, the antenna 248 may be formed as an antenna array including a plurality of antenna elements which may be used for beamforming. In this case, for example, the third RFIC 226 may include a plurality of phase shifters 238 corresponding to the plurality of antenna elements, as part of the third RFFE 236. During transmission, each of the plurality of phase shifters 238 may change a phase of a 5G Above6 RF signal to be transmitted to the outside of the electronic device 101 (e.g., a base station in the 5G network) via a corresponding antenna element. During reception, each of the phase shifters 238 may change a phase of a 5G Above6 RF signal received from the outside via a corresponding antenna element to the same or substantially same phase. This enables transmission or reception via beamforming between the electronic device 101 and the outside.

The second cellular network 294 may be operated independently of the first cellular network 292 (e.g., stand-alone (SA)) or in connection to the first cellular network 292 (e.g., non-stand alone (NSA)). For example, in the 5G network, only an access network (e.g., a 5G radio access network (RAN) or next generation RAN (NG RAN)) may exist, and a core network (e.g., a next generation core (NGC)) may not exist. In this case, after accessing the access network of the 5G network, the electronic device 101 may access an external network (e.g., an Internet) under the control of a core network (e.g., an evolved packet core (EPC)) of the legacy network. Protocol information for a communication with the legacy network (e.g., LTE protocol information) and protocol information for a communication with the 5G network (e.g., new radio (NR) protocol information) may be stored in the memory 130 and accessed by another component (e.g., the processor 120, the first communication processor 212, or the second communication processor 214).

A keep alive mechanism for periodically checking network status has been applied to various services, and a representative example thereof may be a voice over internet protocol (VOIP) service (e.g., a call and message continuity (CMC) service).

The CMC service may be a service which extends a telephone function and/or a text messaging function of an electronic device (e.g., an electronic device in FIG. 1, 2A, or 2B) (e.g., a smart phone) to at least one external electronic device (e.g., an electronic device 102 in FIG. 1) (e.g., a tablet and/or a smart watch) registered based on a user account identical to a user account of the electronic device. Since the CMC service extends the telephone function and/or the text messaging function based on a universal subscriber identity module (USIM) of a communication carrier to which the electronic device is subscribed, there may be no need for the USIM to be inserted into the external electronic device.

The telephone function provided in the CMC service uses a session initiation protocol (SIP) for signaling. The telephone function provided in the CMC service, which is the VoIP service, has a characteristic which is very sensitive to reception delay (e.g., packet delay). However, since packets in the CMC service are transmitted and received through a general Internet network except for a server (e.g., a server 108 in FIG. 1) (an application server (AS)) (e.g., a CMC server), it may be very difficult to manage delay which occurs between endpoint electronic devices. Since the CMC service does not support dedicated network resources provided through an operator network, a keep alive operation may be essential to maintain a transmission control protocol (TCP) connection between the electronic device and/or external electronic device and the CMC server.

The keep alive mechanism may be a mechanism which prevents the TCP connection from being terminated by at least one of routers located between the electronic device and the AS by transmitting a set packet (e.g., a dummy packet) even though there is no packet to be transmitted from the electronic device to the AS (for example, even though it is in a connection idle state), in order to maintain the TCP connection between the electronic device and the AS.

The electronic device and/or the external electronic device may transmit a ping message to the AS in the connection idle state, and the routers existing on a path between the electronic device and/or the external electronic device and the AS may recognize that the TCP connection between the electronic device and/or the external electronic device and the AS is valid by forwarding the ping message to the AS. The AS receiving the ping message may transmit a pong message in response to the ping message, and the electronic device and/or the external electronic device may recognize that the TCP connection between the electronic device and/or the external electronic device and the AS is valid if the electronic device and/or the external electronic device receives the pong message transmitted by the AS. At least one of the ping message or the pong message may be a keep alive message related to the keep alive operation.

In general, if the electronic device and/or the external electronic device frequently transmits a ping message, it may be advantageous in terms of maintaining the TCP connection between the electronic device and/or the external electronic device and the AS. However, since the electronic device and/or the external electronic device needs to frequently wake up to transmit the ping message, it may be disadvantageous in terms of current consumption. In this way, since a period for transmitting the ping message is in a trade-off relationship with the current consumption, determining the keep alive period may be an important issue for the electronic device and/or the external electronic device.

The keep alive period may depend on an App in which the TCP connection is established, and a scheme of determining the keep alive period may include a first scheme in which the keep alive period is determined by the AS when the electronic device and/or the external electronic device are registered with the AS, a second scheme in which the electronic device and/or the external electronic device determines the keep alive period suitable for a network environment by itself, or a third scheme in which the first scheme and the second scheme are combined. The second scheme may also be referred to as a “keep alive discovery scheme.”

If the keep alive discovery scheme is applied, the electronic device and/or the external electronic device may determine a keep alive period suitable for the electronic device by starting from a default keep alive period and increasing it by a set value. In the keep alive discovery scheme, the electronic device and/or the external electronic device may identify whether the keep alive operation is successful by whether a pong message is received for the ping message transmitted from the electronic device and/or the external electronic device, and do not consider delay time for the pong message. For example, whether the pong message is received 10 milliseconds or 10 seconds after the ping message is transmitted, it does not affect an operation of adjusting the keep alive period (e.g., lengthening the keep alive period). However, as the period for transmitting the ping message becomes longer, the reception delay for the pong message may become longer, and this may be related to routing priorities of routers existing on the path between the electronic device and/or the external electronic device and the AS.

Delay which may occur when a router processes a packet may include forwarding delay, propagation delay, serialization delay, and/or queuing delay. The queuing delay may occupy the largest proportion of delays which occur in routing, and to resolve the queuing delay, a router may apply a priority-based scheduling scheme. The priority-based scheduling scheme may include a priority queuing scheme, a weight fair queuing (WFQ) scheme, and/or a class-based weight fair queuing (CBWFQ) scheme.

The router may classify packets into a set number of classes, temporarily store each packet in a class queue to which a priority is assigned, and then process the packets according to the priority. A priority for the packet may vary according to an implementation scheme of a manufacturer manufacturing the router and/or a router operating policy. However, considering that a priority of a TCP socket in which a transmission/reception period for a packet is long (for example, whose transmission/reception frequency for the packet is low) may generally be considered to be low, a socket in which a packet is not received for a long time may be stored in a class queue to which a low priority is assigned, so there may be a high possibility to cause a relatively long delay. Accordingly, the longer the keep alive period, the higher a probability that a delay occurs in a response to a ping message or a session layer message (e.g., at least one of a SIP message or a hypertext transfer protocol (HTTP) message).

An electronic device and/or an external electronic device which provide a VoIP service may need to be able to receive a packet without delay for fast call reception. The electronic device and/or the external electronic device may need to maintain a TCP connection with an AS based on a keep alive mechanism. However, if the keep alive period is set to be long only for maintaining the TCP connection, a case may occur that a packet is received late by at least some of routers existing in an Internet core network. So, the electronic device and/or the external electronic device which provide the VoIP service may need to consider not only an aspect of maintaining the TCP connection but also an aspect of mitigating (for example, preventing, reducing, or minimizing) packet delay when determining the keep alive period.

In addition, electronic devices which attach to the same AS and exist in the same network environment (for example, attach to the same wireless fidelity (Wi-Fi) access point (AP)) may determine a keep alive period based on a keep alive discovery scheme. In this case, a keep alive period of each of the electronic devices which attach to the same WiFi AP may be highly likely to converge to similar or substantially the same value. For example, if there are two electronic devices (for example, a first electronic device and a second electronic device) which are powered on at different time points, it may be expected that the first electronic device which is powered on first may determine the keep alive period first. Accordingly, the first electronic device which determines the keep alive period first may inform the second electronic device which is powered on later of the keep alive period determined by the first electronic device, and in this case, the second electronic device may perform a keep alive operation based on the keep alive period determined by the first electronic device, thereby obtaining a gain in terms of current consumption.

An embodiment of the disclosure may provide an electronic device for managing a keep alive period and an operating method thereof.

An embodiment of the disclosure may provide an electronic device for managing a keep alive period and an operating method thereof so that a reception delay may be mitigated.

An embodiment of the disclosure may provide an electronic device for managing a keep alive period and an operating method thereof so that a keep alive period may be shared.

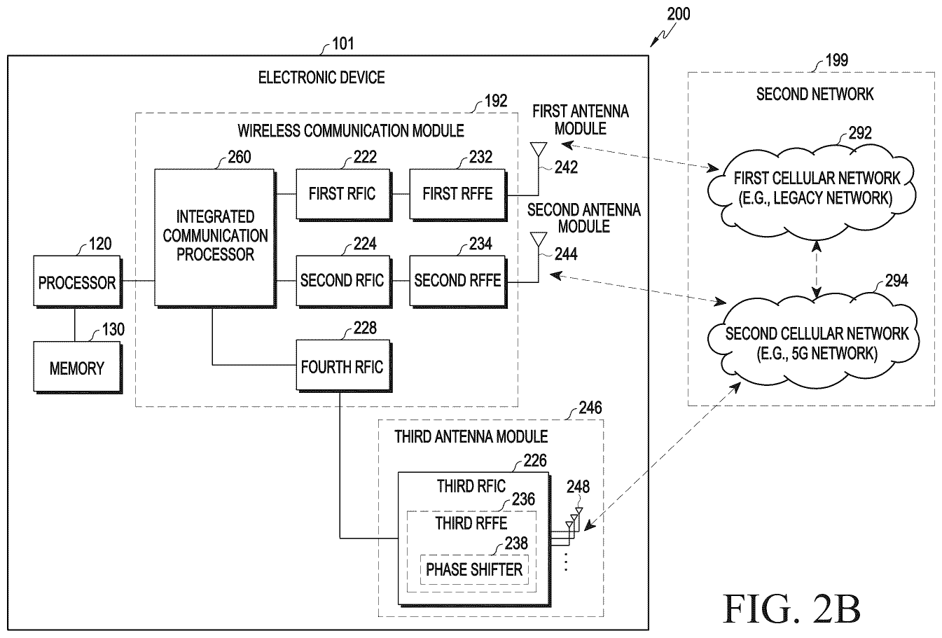

FIG. 3 is a diagram illustrating a network environment to which a keep alive mechanism is applied according to an embodiment of the disclosure.

Referring to FIG. 3, an electronic device 101 (e.g., an electronic device 101 in FIG. 1, 2A, or 2B) may be an electronic device providing a VoIP service (e.g., a CMC service). In an embodiment, the electronic device 101 may determine a keep alive period based on a keep alive discovery scheme. The electronic device 101 may operate as a primary device (PD). According to an embodiment, the electronic device 101 may determine the keep alive period by considering not only an aspect of maintaining a TCP connection between an AS 300 (e.g., a server 108 in FIG. 1) and the electronic device 101 but also an aspect of mitigating (for example, preventing, reducing, or minimizing) a reception delay (e.g., a packet delay). In an embodiment, the reception delay may include a first reception delay associated with a keep alive message and a second reception delay associated with a session layer message (e.g., at least one of a SIP message or an HTTP message).

In an embodiment, if the reception delay occurs, the electronic device 101 may adjust a keep alive period which is being applied at a time point when the reception delay occurs. In an embodiment, if the reception delay occurs, the electronic device 101 may change the keep alive period to a keep alive period immediately before the currently applied keep alive period. In an embodiment, when the reception delay occurs, the electronic device 101 may change the keep alive period to a default keep alive period. The default keep alive period may be set in advance and may be determined based on various parameters.

An electronic device 102 (e.g., an electronic device 102 in FIG. 1), an electronic device 302, and/or an electronic device 304 may attach to the same AS 300 as the electronic device 101 and may exist in the same network environment as the electronic device 101 (for example, may attach to the same WiFi AP). Each of the electronic device 102, the electronic device 302, and/or the electronic device 304 may be an external electronic device, and operate as a secondary device SD. In an embodiment, the electronic device 102, the electronic device 302, and/or the electronic device 304 may also determine a keep alive period based on the keep alive discovery scheme, similar to the electronic device 101.

In an embodiment, the electronic device 101 may be powered on before other electronic devices 102, 302, and/or 304, and thus may have a higher probability of determining the keep alive period before the other electronic devices 102, 302, and/or 304. So, if the electronic device 101 determines the keep alive period before the other electronic devices 102, 302, and/or 304, the electronic device 101 which determines the keep alive period first may inform the other electronic devices 102, 302, and/or 304 of the keep alive period determined by the electronic device 101, and in this case, the other electronic devices 102, 302, and/or 304 may perform a keep alive operation based on the keep alive period determined by the electronic device 101. So, the electronic device 102, the electronic device 302, and/or the electronic device 304 may no longer need to perform an operation of determining the keep alive period based on the keep alive discovery scheme, thereby the electronic device 102, the electronic device 302, and/or the electronic device 304 may obtain a gain in terms of current consumption.

In an embodiment, a scheme in which the electronic device 101 shares the keep alive period determined by the electronic device 101 with the other electronic devices 102, 302, and/or 304 may include at least one of a first sharing scheme of sharing the keep alive period via the AS 300, or a second sharing of sharing the keep alive period via a direct communication. In an embodiment, the direct communication may include a communication based on a peer to peer (P2P) scheme.

According to an embodiment of the disclosure, an electronic device (e.g., an electronic device 101 in FIG. 1, 2A, 2B, or 3) may include at least one communication circuit (e.g., a communication module 190 in FIG. 1, or a wireless communication module 192 in FIG. 2A or 2B), and at least one processor (e.g., a processor 120 in FIG. 1, a processor 120, a first communication processor 212, or a second communication processor 214 in FIG. 2A, or a processor 120 or an integrated communication processor 260 in FIG. 2B) operably connected to the at least one communication circuit (e.g., the communication module 190 in FIG. 1, or the wireless communication module 192 in FIG. 2A or 2B).

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to control the at least one communication circuit (e.g., the communication module 190 in FIG. 1, or the wireless communication module 192 in FIG. 2A or 2B) to establish a connection with a server (e.g., a server 108 in FIG. 1 or an AS 300 in FIG. 3).

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to, for the connection, identify whether at least one of a first condition or a second condition related to a reception delay is satisfied.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to, based on the at least one of the first condition or the second condition being satisfied, adjust a keep alive period for the connection.

According to an embodiment of the disclosure, the first condition may include a condition that first reception delay time related to a keep alive message exceeds threshold delay time.

According to an embodiment of the disclosure, the second condition may include a condition that second reception delay time related to a session layer message exceeds the threshold delay time.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to change the keep alive period to a keep alive period applied before the keep alive period.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to change the keep alive period to a default keep alive period.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to identify whether a set number of times is reached.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to, based on the set number of times not being reached, change the keep alive period to a keep alive period applied before the keep alive period.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to, based on the set number of times being reached, change the keep alive period to a default keep alive period.

According to an embodiment of the disclosure, the keep alive message may include at least one of a ping message or a pong message.

According to an embodiment of the disclosure, the first reception delay time may include time from when the ping message is transmitted until when the pong message is received in response to the ping message.

According to an embodiment of the disclosure, the second delay time may include a difference between a time point at which the session layer message is transmitted and a time point at which the session layer message is received.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to control the at least one communication circuit (e.g., the communication module 190 in FIG. 1, or the wireless communication module 192 in FIG. 2A or 2B) to transmit, to the server (e.g., the server 108 in FIG. 1 or the AS 300 in FIG. 3), a first message including at least the adjusted keep alive period.

According to an embodiment of the disclosure, the first message may include a basic service set identifier (BSSID) of an access point (AP) to which the electronic device 101 in FIG. 1, 2A, 2B, or 3) attaches.

According to an embodiment of the disclosure, the at least one processor (e.g., the processor 120 in FIG. 1, the processor 120, the first communication processor 212, or the second communication processor 214 in FIG. 2A, or the processor 120 or the integrated communication processor 260 in FIG. 2B) may be configured to control the at least one communication circuit (e.g., the communication module 190 in FIG. 1, or the wireless communication module 192 in FIG. 2A or 2B) to transmit a first message including at least the adjusted keep alive period.

According to an embodiment of the disclosure, the first message may be transmitted based on one of a broadcast scheme or a multicast scheme.

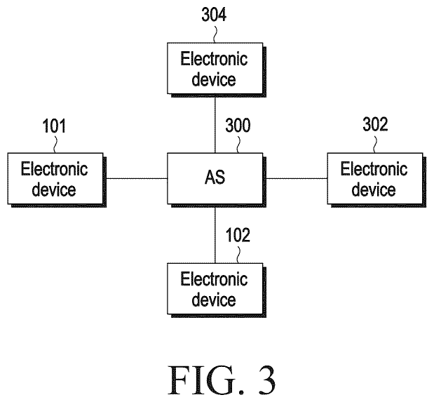

FIG. 4 is a flowchart illustrating an operating process of an electronic device according to an embodiment of the disclosure.

Referring to FIG. 4, an electronic device (e.g., an electronic device 101 in FIG. 1, FIG. 2A, FIG. 2B, or FIG. 3) (e.g., a processor 120 in FIG. 1, a processor 120, a first communication processor 212, or a second communication processor 214 in FIG. 2A, or a processor 120, or an integrated communication processor 260 in FIG. 2B) may control at least one communication circuit (e.g., a communication module 190 in FIG. 1, or a wireless communication module 192 in FIG. 2A or FIG. 2B) to establish a connection (e.g., a TCP connection) with a server (e.g., a server 108 in FIG. 1 or an AS 300 in FIG. 3) in operation 411.

In operation 413, the electronic device may identify whether at least one of a first condition or a second condition related to a reception delay (e.g., a packet delay) is satisfied for the established connection. In an embodiment, a fact that the at least one of the first condition or the second condition is satisfied may mean that the reception delay occurs. In an embodiment, the first condition may include a condition in which first reception delay time related to a keep alive message (e.g., at least one of a ping message or a pong message) exceeds threshold delay time. The threshold delay time may be set to guarantee a stable service quality in a VoIP service (e.g., a CMC service) and may be set based on various parameters. In an embodiment, the threshold delay time may be notified to the electronic device by the server when the electronic device is registered with the server. In an embodiment, the threshold delay time may be notified by the server to the electronic device when at least one external electronic device (e.g., an electronic device 102 in FIG. 1) (e.g., a tablet and/or a smart watch) which is registered based on a user account identical to a user account of the electronic device is registered with the server.

In an embodiment, the second condition may include a condition in which second reception delay time related to a session layer message (e.g., at least one of a SIP message or an HTTP message) exceeds the threshold delay time. In an embodiment, the threshold delay time may be set based on a timer value (e.g., 500 ms) of a timer T1 which is one of timers specified in an SIP. For example, the threshold delay time may be set to 1 second, which is twice the timer value of the timer T1.

As a result of identification in operation 413, if the at least one of the first condition or the second condition is satisfied, the electronic device may adjust a keep alive period for the connection connected between the electronic device and the server in operation 415. In an embodiment, the electronic device may change the keep alive period for the connection to a keep alive period applied before a keep alive period currently applied to the connection. In an embodiment, the electronic device may change the keep alive period for the connection to a default keep alive period. In an embodiment, the electronic device may identify whether a set number of times has been reached, and if the set number of times has not been reached, the electronic device may change the keep alive period for the connection to the keep alive period applied before the keep alive period currently applied. In an embodiment, if the set number of times has been reached as the result of identification, the keep alive period for the connection may be changed to the default keep alive period. For example, if a reception delay occurs despite the electronic device performing an operation of changing the keep alive period for the connection to the keep alive period applied before the keep alive period currently applied for the connection the set number of times, as the at least one of the first condition or the second condition is satisfied, the electronic device may more quickly determine a keep alive period which is suitable for (for example, optimized for) the electronic device by changing to the default keep alive period rather than changing to the keep alive period applied before the keep alive period currently applied for the connection.

In FIG. 4, it has been described that if the at least one of the first condition or the second condition is satisfied, the electronic device adjusts the keep alive period for the connection connected between the electronic device and the server. However, the electronic device may release the connection connected between the electronic device and the server, establish a new connection with the server, and determine a keep alive period for the new connection without adjusting the keep alive period.

In an embodiment, the first reception delay time related to the keep alive message may include time it takes for the electronic device to transmit a ping message to the AS and to receive a pong message from the AS in response to the ping message. For example, if a time point at which the electronic device transmits the ping message is “a” and a time point at which the electronic device receives the pong message is “b”, the first reception delay time may be time corresponding to “b-a”.

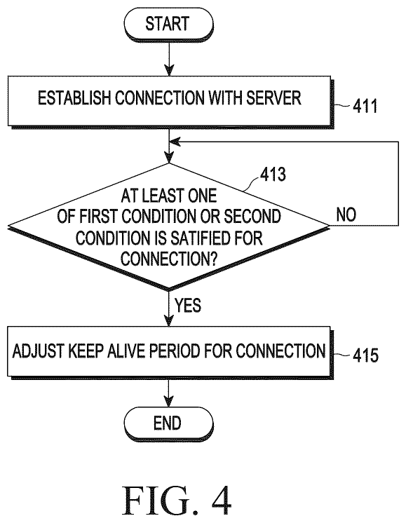

In an embodiment, the second reception delay time related to the session layer message will be described with reference to FIG. 5.

FIG. 5 is a diagram illustrating second reception delay time related to a session layer message according to an embodiment of the disclosure.

Referring to FIG. 5, when transmitting a session layer message (e.g., a SIP message or an HTTP message), an electronic device 101 (e.g., an electronic device 101 in FIG. 1, FIG. 2A, FIG. 2B, or FIG. 3) may include information (e.g., a time stamp) about a transmission time point in a header of the session layer message. In an embodiment, the electronic device 101 may be an electronic device providing a CMC service. In FIG. 5, it will be assumed that the session layer message is an invite message of an SIP. In operation 511, the electronic device 101 may transmit an INVITE message including information about a transmission time point (e.g., Cmc-SendTime: 28/05/2022 00:07:33.959) to an AS 300 (e.g., a server 108 in FIG. 1 or an AS 300 in FIG. 3). In an embodiment, the AS 300 may be a CMC server.

The AS 300 which receives the INVITE message from the electronic device 101 may transmit an INVITE message to an electronic device 102 (e.g., an electronic device 102 in FIG. 1 or FIGS. 2A and 2B) via an Internet core network 500 in operation 513. The AS 300 may include information (e.g., Cmc-SendTime: a) about a time point at which the AS 300 transmits the INVITE message in the INVITE message.

The electronic device 102 may receive the INVITE message transmitted from the AS 300 via the Internet core network 500, and in operation 515, may identify a time point at which the electronic device 102 receives the INVITE message. For example, the time point at which the electronic device 102 receives the INVITE message may be “b”. The electronic device 102 may identify, as the second reception delay time, time corresponding to “b-a” which is difference between a time point at which the AS 300 transmits the INVITE message and a time point at which the electronic device 102 receives the INVITE message. An operation of adjusting the keep alive period based on the second reception delay time may be implemented similar to or substantially the same as that described in FIG. 4, so a detailed description thereof will be omitted herein.

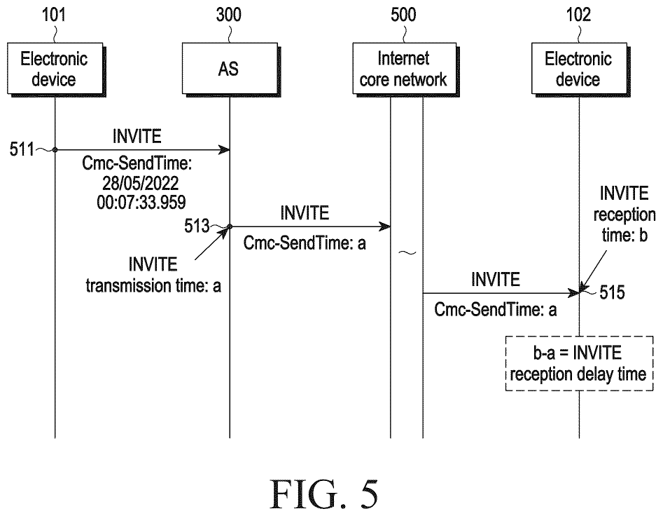

FIG. 6 is a diagram for explaining an operation of adjusting a keep alive period in a case that first reception delay time related to a keep alive message exceeds threshold delay time according to an embodiment of the disclosure.

Referring to FIG. 6, an electronic device (e.g., an electronic device 101 in FIG. 1, FIG. 2A, FIG. 2B, or FIG. 3) may adjust a currently applied keep alive period if first reception delay time related to a keep alive message exceeds threshold delay time. In FIG. 6, it will be assumed that the keep alive message is a pong message.

The electronic device may identify that a reception delay occurs for a connection (e.g., a TCP connection) established between the electronic device and a server (e.g., a server 108 in FIG. 1 or an AS 300 in FIG. 3) in operation 611. For example, the electronic device may identify that first reception delay time taken for a pong message to be received after transmitting a ping message exceeds threshold delay time in operation 611. FIG. 6 illustrates an example of identifying that the reception delay occurs if a pong delay is detected (for example, if first reception delay time related to a keep alive message exceeds the threshold delay time), however, it is also possible to identify that the reception delay occurs if a session layer message delay is detected (for example, if second reception delay time related to a session layer message exceeds the threshold delay time).

When identifying that the first reception delay time exceeds the threshold delay time, the electronic device may change the keep alive period for the connection to a keep alive period applied before the currently applied keep alive period for the connection in operation 613. In FIG. 6, since the keep alive period applied to the connection at a time point at which the reception delay occurs is T4, the electronic device may change the keep alive period for the connection to T3, which is a keep alive period applied before T4, which is the currently applied keep alive period in operation 613.

In an embodiment, an electronic device may store a keep alive period in a case that a reception delay occurs, and may not set a keep alive period longer than or equal to the stored keep alive period if a reception delay occurs in the future.

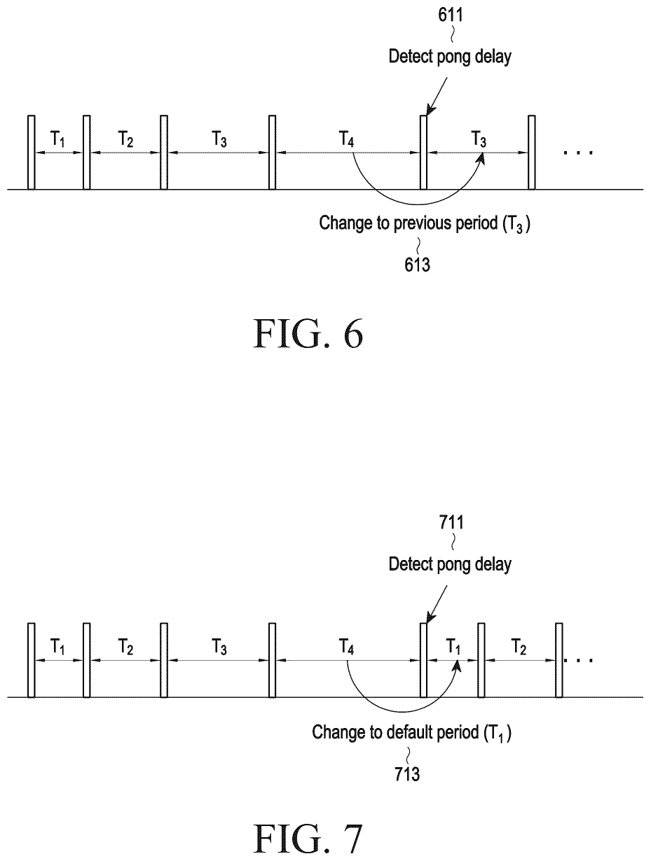

FIG. 7 is a diagram for explaining an operation for adjusting a keep alive period in a case that first reception delay time related to a keep alive message exceeds threshold delay time according to an embodiment of the disclosure.

Referring to FIG. 7, an electronic device (e.g., an electronic device 101 in FIG. 1, FIG. 2A, FIG. 2B, or FIG. 3) may adjust a currently applied keep alive period if first reception delay time related to a keep alive message exceeds threshold delay time. In FIG. 7, it will be assumed that the keep alive message is a pong message.

The electronic device may identify that a reception delay occurs for a connection (e.g., a TCP connection) established between the electronic device and a server (e.g., a server 108 in FIG. 1 or an AS 300 in FIG. 3) in operation 711 (for example, detection of a pong delay). For example, the electronic device may identify that first reception delay time taken until a pong message is received after transmitting a ping message exceeds threshold delay time in operation 711.

When identifying that the first reception delay time exceeds the threshold delay time, the electronic device may change a keep alive period for the connection to a default keep alive period for the connection in operation 713. In FIG. 7, since a keep alive period applied to the connection at a time point at which the reception delay occurs is T4, the electronic device may change the keep alive period for the connection to T1 which is the default keep alive period in operation 713.

In an embodiment, an electronic device may store a keep alive period in a case that a reception delay occurs, and may not set a keep alive period longer than or equal to the stored keep alive period if a reception delay occurs in the future.

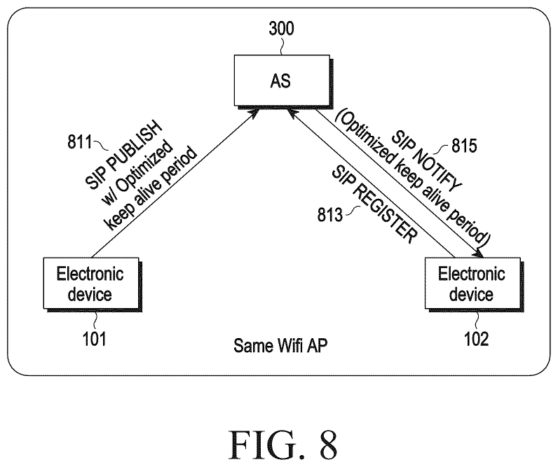

FIG. 8 is a diagram for explaining an operation of sharing a keep alive period between electronic devices according to an embodiment of the disclosure.

Referring to FIG. 8, an electronic device 101 (e.g., an electronic device 101 in FIG. 1, FIG. 2A, FIG. 2B, or FIG. 3) may attach to the same AS 300 (e.g., a server 108 in FIG. 1 or an AS 300 in FIG. 3) as an electronic device 102 (e.g., an electronic device 102 in FIG. 1 or FIG. 3), and the electronic device 101 and the electronic device 102 may exist in the same network environment (e.g., may attach to the same WiFi AP). The electronic device 101 may be an electronic device providing a CMC service, and the AS 300 may be a CMC server. The electronic device 101 may operate as a PD, and the electronic device 102 may operate as an SD. In an embodiment, the electronic device 101 and the electronic device 102 may determine a keep alive period based on a keep alive discovery scheme.

In an embodiment, the electronic device 101 may be powered on before the electronic device 102, and thus may have a higher probability of determining the keep alive period before the electronic device 102. So, if the electronic device 101 determines the keep alive period before the electronic device 102, the electronic device 101 which determines the keep alive period first may inform the electronic device 102 of the keep alive period determined by the electronic device 101, and in this case, the electronic device 102 may perform a keep alive operation based on the keep alive period determined by the electronic device 101. So, the electronic device 102 may no longer need to perform the operation of determining the keep alive period based on the keep alive discovery scheme, and thus, the electronic device 102 may obtain a gain in terms of current consumption.

So, the electronic device 101 may inform the electronic device 102 of the keep alive period determined by the electronic device 101 via the AS 300 (operations 811 and 813). In operation 811, the electronic device 101 may transmit a message (e.g., a SIP PUBLISH message) including the keep alive period (e.g., an optimized keep alive period) determined by the electronic device 101 to the AS 300. In an embodiment, the electronic device 101 may transmit the SIP PUBLISH message to the AS 300 whenever the keep alive period is adjusted. In FIG. 8, the message including the keep alive period has been described using the SIP PUBLISH message as an example, but the message including the keep alive period may be implemented as other messages such as a SIP REQUEST message as well as the SIP PUBLISH message.

The AS (300) which receives the SIP PUBLISH message including the keep alive period determined by the electronic device 101 may receive a SIP REGISTER message from the electronic device 102 in operation 813. Since the electronic device 102 exists in the same network environment as the electronic device 101 (for example, attaches to the same WiFi AP), the electronic device 102 may transmit a message (for example, a notification message (for example, a SIP NOTIFY message) or a register response message (for example, a 200 OK message)) including the keep alive period determined by the electronic device 101 in operation 815. The electronic device 102 which receives the SIP NOTIFY message may no longer need to perform the operation of determining the keep alive period based on the keep alive discovery scheme, and thus, the electronic device 102 may obtain a gain in terms of current consumption.

In an embodiment, there may be a plurality of electronic devices which attach to the same AS 300 and exist in the same network environment (for example, attach to the same WiFi AP), and at least two of the plurality of electronic devices may transmit a SIP PUBLISH message including a determined keep alive period (e.g., an optimized keep alive period) to the AS 300. In this case, the keep alive periods transmitted by the at least two electronic devices to the AS 300 may be different, and the AS 300 may select one of the received keep alive periods and include the selected keep alive period in a message (e.g., at least one of a registration response message (e.g., a 200 OK message) or a notification message (e.g., a SIP NOTIFY message)) transmitted to an electronic device newly registering with the AS. In an embodiment, the selected keep alive period may be a keep alive period with a minimum period among the received keep alive periods.

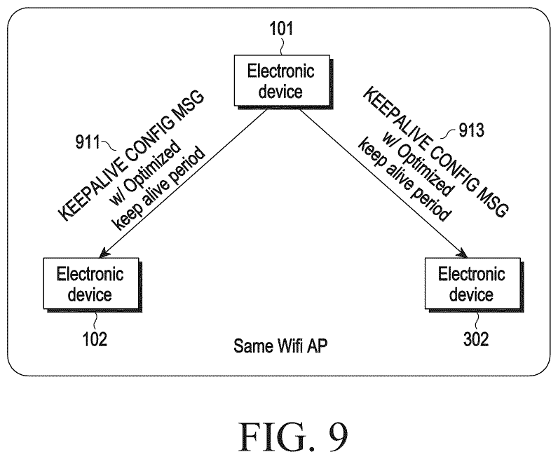

FIG. 9 is a diagram for explaining an operation of sharing a keep alive period between electronic devices according to an embodiment of the disclosure.

Referring to FIG. 9, an electronic device 101 (e.g., an electronic device 101 in FIG. 1, FIG. 2A, FIG. 2B, or FIG. 3) may exist in the same network environment (for example, may attach to the same WiFi AP) as an electronic device 102 (e.g., an electronic device 102 in FIG. 1 or FIG. 3) and an electronic device 302 (e.g., an electronic device 302 in FIG. 3). Each of the electronic device 101, the electronic device 102, and the electronic device 302 may be an electronic device providing a CMC service. The electronic device 101, the electronic device 102, and the electronic device 302 may determine a keep alive period based on a keep alive discovery scheme. In an embodiment, the electronic device 101, the electronic device 102, and the electronic device 302 may perform a direct communication (e.g., a P2P communication).

In an embodiment, the electronic device 101 may be powered on before the electronic device 102, and thus may have a higher probability of determining the keep alive period before the electronic device 102. So, if the electronic device 101 determines the keep alive period before the electronic device 102, the electronic device 101 which determines the keep alive period first may inform the electronic device 102 and the electronic device 302 of the keep alive period determined by the electronic device 101. Therefore, the electronic device 102 and the electronic device 302 may no longer need to perform an operation of determining the keep alive period based on the keep alive discovery scheme, and thus, the electronic device 102 and the electronic device 302 may obtain a gain in terms of current consumption.

So, the electronic device 101 may inform the keep alive period determined by the electronic device 101 based on a broadcast scheme and/or a multicast scheme (operations 911 and 913). In operations 911 and 913, the electronic device 101 may transmit a message (e.g., a keep alive configuration message: KEEPAVLIVE CONFIG MSG) including the keep alive period (e.g., an optimized keep alive period) determined by the electronic device 101 based on the broadcast scheme and/or the multicast scheme. In an embodiment, the electronic device 101 may transmit the KEEPAVLIVE CONFIG MSG whenever the electronic device 101 adjusts the keep alive period.

Since the electronic device 102 and the electronic device 302 exist in the same network environment as the electronic device 101 (for example, attach to the same WiFi AP), the electronic device 102 and the electronic device 302 may receive the KEEPAVLIVE CONFIG MSG transmitted by the electronic device 101. The electronic device 102 and the electronic device 302 which receives the KEEPAVLIVE CONFIG MSG may no longer need to perform the operation of determining the keep alive period based on the keep alive discovery scheme, and thus, the electronic device 102 and the electronic device 302 may obtain a gain in terms of current consumption.

In an embodiment, there may be a plurality of electronic devices which exist in the same network environment (for example, attach to the same WiFi AP), and at least two of the plurality of electronic devices may transmit a KEEPAVLIVE CONFIG MSG message including a determined keep alive period (e.g., an optimized keep alive period) based on a broadcast scheme and/or a multicast scheme. In this case, the keep alive periods transmitted by the at least two electronic devices may be different. An arbitrary electronic device which receives the KEEPAVLIVE CONFIG MSG transmitted by each of the at least two electronic devices may select one of the plurality of keep alive periods and operate corresponding to the selected keep alive period. In an embodiment, the selected keep alive period may be a keep alive period with a minimum period among the plurality of keep alive periods. In an embodiment, if the arbitrary electronic device which receives the KEEPAVLIVE CONFIG MSG transmitted by each of at least two electronic devices has already determined the keep alive period (for example, if the keep alive period has already been determined based on the keep alive discovery scheme), the arbitrary electronic device may ignore the received KEEPAVLIVE CONFIG MSGs. In an embodiment, if the arbitrary electronic device which receives the KEEPAVLIVE CONFIG MSG transmitted by each of at least two electronic devices has already determined the keep alive period, the arbitrary electronic device may compare the keep alive period determined by the arbitrary electronic device itself with the keep alive periods included in the received KEEPAVLIVE CONFIG MSGs. As a result of the comparison, if there is a keep alive period shorter than the keep alive period determined by the arbitrary electronic device itself among the keep alive periods included in the received KEEPAVLIVE CONFIG MSGs, the arbitrary electronic device may change the keep alive period to the corresponding keep alive period.

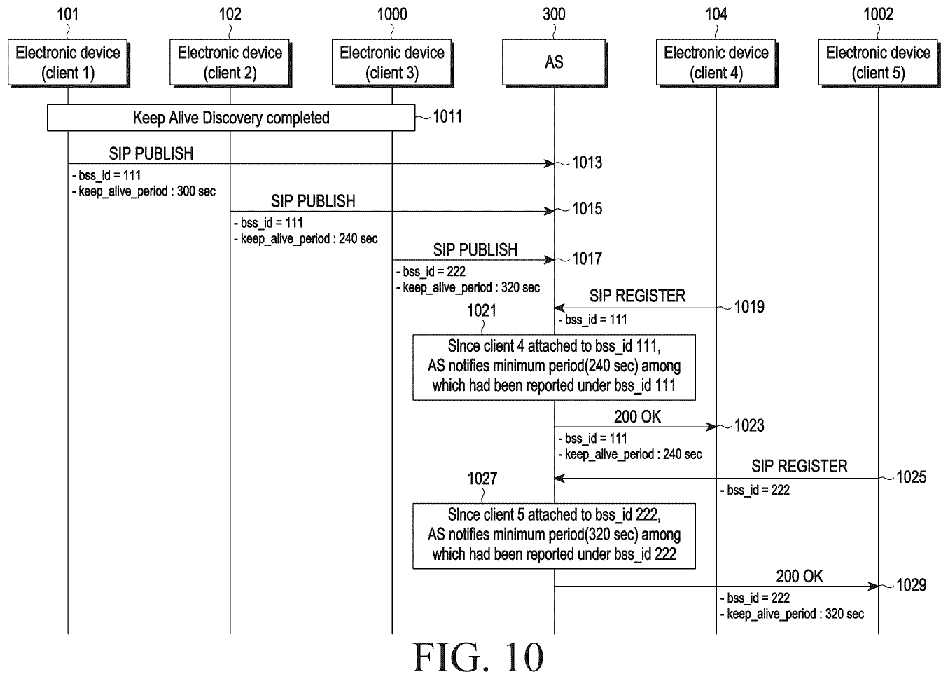

FIG. 10 is a signal flow diagram illustrating an operation of sharing a keep alive period between electronic devices according to an embodiment of the disclosure.

Referring to FIG. 10, an electronic device 101 (e.g., an electronic device 101 in FIG. 1, FIG. 2A, FIG. 2B, or FIG. 3), an electronic device 102 (e.g., an electronic device 102 in FIG. 1 or FIG. 3), and an electronic device 104 (e.g., an electronic device 104 in FIG. 1) may attach to the same AS 300 (e.g., a server 108 in FIG. 1 or an AS 300 in FIG. 3) and may exist in the same network environment (for example, may attach to the same WiFi AP). In an embodiment, the electronic device 101, the electronic device 102, and/or the electronic device 104 may be an electronic device providing a CMC service, and the AS 300 may be a CMC server. Each of the electronic device 101, the electronic device 102, and/or the electronic device 104 may operate as a client and attach to a WiFi AP with a BSSID of “111”. The electronic device 101, the electronic device 102, and/or the electronic device 104 may determine a keep alive period based on a keep alive discovery scheme.

An electronic device 1000 and/or an electronic device 1002 may attach to the same AS 300 and may attach to the same WiFi AP. The electronic device 1000 and/or the electronic device 1002 may attach to a WiFi AP with a BSSID of “222”. The electronic device 1000 and/or the electronic device 1002 may be an electronic device providing the CMC service and may determine the keep alive period based on the keep alive discovery scheme. Each of the electronic device 1000 and/or the electronic device 1002 may operate as the client.

In FIG. 10, the electronic device 101, the electronic device 102, and/or the electronic device 1000 may determine the keep alive period based on the keep alive discovery scheme in operation 1011 (keep alive discovery completed).

The electronic device 101 which determines the keep alive period may transmit a message (e.g., SIP PUBLISH message) including a keep alive period (e.g., 300 sec) determined by the electronic device 101 and/or a BSSID to which the electronic device 101 attaches, to the AS 300 in operation 1013. The electronic device 102 which determines the keep alive period may transmit a message (e.g., a SIP PUBLISH message) including a keep alive period (e.g., 240 sec) determined by the electronic device 102 and/or a BSSID to which the electronic device 102 attaches to the AS 300 in operation 1015. The electronic device 1000 which determines the keep alive period may transmit a message (e.g., a SIP PUBLISH message) including a keep alive period (e.g., 320 sec) determined by the electronic device 1000 and/or a BSSID to which the electronic device 1000 attaches to the AS 300 in operation 1017.

Thereafter, the electronic device 104 may attempt to register with the AS 300, and thus may transmit a SIP RESISTER message to the AS 300 in operation 1019. In an embodiment, the SIP RESISTER message may include the BSSID of the WiFi AP to which the electronic device 104 attaches.

The AS 300 which receives the SIP RESISTER message from the electronic device 104 may determine one of the keep alive periods for the electronic devices (e.g., the electronic device 101 and/or the electronic device 102) which attach to the same WiFi AP as the electronic device 104 as the keep alive period for the electronic device 104 in operation 1021. In an embodiment, the AS 300 may determine the keep alive period with a minimum period among the keep alive periods for the electronic device 101 and/or the electronic device 102 as the keep alive period for the electronic device 104. The AS 300 which determines the keep alive period for the electronic device 104 may transmit a 200 OK message to the electronic device 104 in response to the SIP RESISTER message in operation 1023. The 200 OK message may include the BSSID of the WiFi AP to which the electronic device 104 attaches and/or the keep alive period determined for the electronic device 104. In FIG. 10, a case that the BSSID of the WiFi AP to which the electronic device 104 attaches and/or the keep alive period determined for the electronic device 104 are notified using the 200 OK message has been described as an example, however, the BSSID of the WiFi AP to which the electronic device 104 attaches and/or the keep alive period determined for the electronic device 104 may be also notified using a separate message, such as a SIP NOTIFY message.

The electronic device 104 which receives the 200 OK message may use the keep alive period included in the 200 OK message as the keep alive period of the electronic device 104, or may use it as a default keep alive period. In this way, the electronic device 104 which receives the 200 OK message may no longer need to perform an operation of determining the keep alive period based on the keep alive discovery scheme, and thus, the electronic device 104 may obtain a gain in terms of current consumption.

Additionally, the electronic device 1002 may attempt to register with the AS 300, and thus may transmit a SIP REGISTER message to the AS 300 in operation 1025. In an embodiment, the SIP REGISTER message may include the BSSID of the WiFi AP to which the electronic device 1002 attaches.

The AS 300 which receives the SIP REGISTER message from the electronic device 1002 may determine one of the keep alive periods for the electronic devices (e.g., the electronic device 1000) which attach to the same WiFi AP as the electronic device 1002 as the keep alive period for the electronic device 1002 in operation 1027. In an embodiment, the AS 300 may determine the keep alive period for the electronic device 1000 as the keep alive period for the electronic device 1002. The AS 300 which determines the keep alive period for the electronic device 1002 may transmit a 200 OK message to the electronic device 1002 as a response to the SIP REGISTER message in operation 1029. The 200 OK message may include the BSSID of the WiFi AP to which the electronic device 1002 attaches and/or the keep alive period determined for the electronic device 1002. In FIG. 10, a case that the BSSID of the WiFi AP to which the electronic device 1002 attaches and/or the keep alive period determined for the electronic device 1002 are notified using the 200 OK message has been described as an example, however, the BSSID of the WiFi AP to which the electronic device 1002 attaches and/or the keep alive period determined for the electronic device 1002 may be also notified using a separate message, such as a SIP NOTIFY message.

The electronic device 1002 which receives the 200 OK message may use the keep alive period included in the 200 OK message as the keep alive period of the electronic device 1002, or may use it as the default keep alive period. In this way, the electronic device 1002 which receives the 200 OK message may no longer need to perform an operation of determining the keep alive period based on the keep alive discovery scheme, and thus, the electronic device 1002 may obtain a benefit in terms of current consumption.

In an embodiment, in the CMC service, a VoIP service may be supported if a parent electronic device and a child electronic device are located in a coverage of the same WiFi AP in a specific mode (a Same Wifi Only mode). So, an electronic device performing a registration procedure may determine a specific keep alive period (e.g., a minimum keep alive period) among a plurality of keep alive periods as a keep alive period of the electronic device without an operation of comparing BSSIDs.

According to an embodiment of the disclosure, a method performed by an electronic device (e.g., an electronic device 101 in FIG. 1, 2A, 2B, or 3) may include establishing (411) a connection with a server (e.g., a server 108 in FIG. 1 or an AS 300 in FIG. 3).

According to an embodiment of the disclosure, the method may include, identifying (413), by the electronic device, whether at least one of a first condition or a second condition related to a reception delay in the connection is satisfied.

According to an embodiment of the disclosure, the method may include, based on the at least one of the first condition or the second condition being satisfied, adjusting (415), by the electronic device, a keep alive period for the connection.

According to an embodiment of the disclosure, the first condition may include a condition that a first reception delay time related to a keep alive message exceeds threshold delay time.

According to an embodiment of the disclosure, the second condition includes a condition that a second reception delay time related to a session layer message exceeds the threshold delay time.

According to an embodiment of the disclosure, adjusting the keep alive period may include changing the keep alive period to another keep alive period applied before the keep alive period.

According to an embodiment of the disclosure, adjusting the keep alive period may include changing the keep alive period to a default keep alive period.

According to an embodiment of the disclosure, adjusting the keep alive period may include identifying whether a set number of times is reached.

According to an embodiment of the disclosure, adjusting the keep alive period may include, based on the set number of times not being reached, changing the keep alive period to another keep alive period applied before the keep alive period.

According to an embodiment of the disclosure, adjusting the keep alive period may include, based on the set number of times being reached, changing the keep alive period to a default keep alive period.

According to an embodiment of the disclosure, the keep alive message may include at least one of a ping message or a pong message.

According to an embodiment of the disclosure, the first reception delay time may include time from when the ping message is transmitted until when the pong message is received in response to the ping message.

According to an embodiment of the disclosure, the second reception delay time may include a difference between a time point at which the session layer message is transmitted and a time point at which the session layer message is received.

According to an embodiment of the disclosure, the operating method may include transmitting, to the server (e.g., the server 108 in FIG. 1 or the AS 300 in FIG. 3), a first message including at least the adjusted keep alive period.

According to an embodiment of the disclosure, the first message may include a basic service set identifier (BSSID) of an access point (AP) to which the electronic device (e.g., the electronic device in FIG. 1, 2A, 2B, or 3) attaches.

According to an embodiment of the disclosure, the operating method may include transmitting a first message including at least the adjusted keep alive period.

According to an embodiment of the disclosure, the first message may be transmitted based on one of a broadcast scheme or a multicast scheme.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
memory storing one or more computer programs;
at least one communication circuit; and
one or more processors communicatively coupled to the memory and the at least one communication circuit,
wherein the one or more computer programs include computer-executable instructions that, when executed by the one or more processors individually or collectively, cause the electronic device to:
control the at least one communication circuit to establish a connection with a server,
identify whether at least one of a first condition or a second condition related to a reception delay in the connection is satisfied, and
based on the at least one of the first condition or the second condition being satisfied, adjust a keep alive period for the connection,
wherein the first condition includes a condition that a first reception delay time related to a keep alive message exceeds a threshold delay time, and
wherein the second condition includes a condition that a second reception delay time related to a session layer message exceeds the threshold delay time.

2. The electronic device of claim 1, wherein the one or more computer programs include computer-executable instructions that, when executed by the one or more processors individually or collectively, cause the electronic device to:
change the keep alive period to another keep alive period applied before the keep alive period.

3. The electronic device of claim 1, wherein the one or more computer programs include computer-executable instructions that, when executed by the one or more processors individually or collectively, cause the electronic device to:
change the keep alive period to a default keep alive period.

4. The electronic device of claim 1, wherein the one or more computer programs include computer-executable instructions that, when executed by the one or more processors individually or collectively, cause the electronic device to:
identify whether a set number of times is reached;
based on the set number of times not being reached, change the keep alive period to another keep alive period applied before the keep alive period; and
based on the set number of times being reached, change the keep alive period to a default keep alive period.

5. The electronic device of claim 1,
wherein the keep alive message includes at least one of a ping message or a pong message, and
wherein the first reception delay time includes time from when the ping message is transmitted until when the pong message is received in response to the ping message.

6. The electronic device of claim 1, wherein the second reception delay time includes a difference between a time point at which the session layer message is transmitted and a time point at which the session layer message is received.

7. The electronic device of claim 1, wherein the one or more computer programs include computer-executable instructions that, when executed by the one or more processors individually or collectively, cause the electronic device to:
control the at least one communication circuit to transmit, to the server, a first message including at least the adjusted keep alive period.

8. The electronic device of claim 1, wherein the one or more computer programs include computer-executable instructions that, when executed by the one or more processors individually or collectively, cause the electronic device to:
control the at least one communication circuit to transmit a first message including at least the adjusted keep alive period.

9. A method performed by an electronic device, the method comprising:
establishing, by the electronic device, a connection with a server;
identifying, by the electronic device, whether at least one of a first condition or a second condition related to a reception delay in the connection is satisfied; and
based on the at least one of the first condition or the second condition being satisfied, adjusting, by the electronic device, a keep alive period for the connection,
wherein the first condition includes a condition that a first reception delay time related to a keep alive message exceeds a threshold delay time, and
wherein the second condition includes a condition that a second reception delay time related to a session layer message exceeds the threshold delay time.

10. The method of claim 9, wherein the adjusting of the keep alive period comprises:
changing the keep alive period to another keep alive period applied before the keep alive period.

11. The method of claim 9, wherein the adjusting of the keep alive period comprises:
changing the keep alive period to a default keep alive period.

12. The method of claim 9, wherein the adjusting of the keep alive period comprises:
identifying whether a set number of times is reached;
based on the set number of times not being reached, changing the keep alive period to another keep alive period applied before the keep alive period; and
based on the set number of times being reached, changing the keep alive period to a default keep alive period.

13. The method of claim 9,
wherein the keep alive message includes at least one of a ping message or a pong message, and
wherein the first reception delay time includes time from when the ping message is transmitted until when the pong message is received in response to the ping message.

14. The method of claim 9, wherein the second reception delay time includes a difference between a time point at which the session layer message is transmitted and a time point at which the session layer message is received.

15. The method of claim 9, further comprising:
transmitting, to the server, a first message including at least the adjusted keep alive period.

16. The method of claim 9, further comprising:
transmitting a first message including at least the adjusted keep alive period.

17. One or more non-transitory computer-readable storage media storing one or more computer programs including computer-executable instructions that, when executed by one or more processors of an electronic device individually or collectively, cause the electronic device to perform operations, the operations comprising:
establishing, by the electronic device, a connection with a server;
identifying, by the electronic device, whether at least one of a first condition or a second condition related to a reception delay in the connection is satisfied; and
based on the at least one of the first condition or the second condition being satisfied, adjusting, by the electronic device, a keep alive period for the connection,
wherein the first condition includes a condition that a first reception delay time related to a keep alive message exceeds a threshold delay time, and
wherein the second condition includes a condition that a second reception delay time related to a session layer message exceeds the threshold delay time.

18. The one or more non-transitory computer-readable storage media of claim 17, the operations further comprising
changing the keep alive period to another keep alive period applied before the keep alive period.
